(19) United States
(12) Patent Application Publication
(10) Pub. No.: US 2025/0126159 A1
(43) Pub. Date: Apr. 17, 2025

(54) Programmable Voice Extension Framework

(71) Applicant: Twilio Inc., San Francisco, CA (US)

(72) Inventors: Christer Jan Erik Fahlgren, San Francisco, CA (US); Torkel Dominique, San Francisco, CA (US); Huipeng Ren, Santa Clara, CA (US)

(21) Appl. No.: 19/000,360

(22) Filed: Dec. 23, 2024

Related U.S. Application Data
(63) Continuation of application No. 16/985,624, filed on Aug. 5, 2020.
(60) Provisional application No. 62/882,873, filed on Aug. 5, 2019.

(51) Int. Cl. H04L 65/1094; H04L 65/1066; H04L 65/61; H04L 65/65

(52) U.S. Cl. CPC H04L 65/1094; H04L 65/1066; H04L 65/61; H04L 65/65

(57) ABSTRACT

Disclosed are systems, methods, and non-transitory computer-readable media for a programmable voice extension framework. A voice extension framework allows customers to develop and implement voice extensions that extend a base set of features and functionality provided by a cloud-based communication platform. The voice extension framework provides a standardized voice extension Application Programming Interface (API) that can be used to develop the voice extensions. Once developed, the voice extension (e.g., piece of software) is added to an extension repository maintained by the cloud-based communication platform, where it may be invoked (e.g., called) to provide the additional feature or functionality. For example, the voice extension may be invoked through use of an extension name designated to the voice extension.

### CROSS-REFERENCE TO RELATED APPLICATIONS

This application is a continuation of U.S. patent application Ser. No. 16/985,624, filed Aug. 5, 2020, which claims the benefit of priority of U.S. Provisional Application No. 62/882,873, filed on Aug. 5, 2019, which is incorporated herein by reference in its entirety. This application is related to co-pending U.S. patent application titled “REAL-TIME MEDIA STREAMS,” U.S. application Ser. No. 16/985,600, filed on Aug. 5, 2020, which claims priority to U.S. Provisional Application No. 62/882,869, filed on Aug. 5, 2019, the contents of which are hereby incorporated by reference in their entireties.

### TECHNICAL FIELD

An embodiment of the present subject matter relates generally to cloud-based communication services and, more specifically, to a programmable voice extension framework.

### BACKGROUND

Communications have transformed rapidly in the past 10 years as traditional phone lines are replaced by Voice Over Internet Protocol (VoIP), instant messaging, video, etc. This transition to providing communications using the Internet has allowed Software as a Service (SasS) providers to provide communication services for their clients. Providing communication as a service frees customers from having to purchase and manage the hardware needed to provide communications. While beneficial to customers, utilizing communication as a service also comes with some drawbacks as each customer has unique communication needs. For example, some customers may wish to provide transcription services or translation services for their voice communications, while other customers may not need these features. Currently, customers of communication SaaS providers are limited to the products provided by the SaaS provider. For example, the SaaS provider may have a limited set of available features from which their customers may choose. If a customer wants additional functionality that is not provided by the SaaS provider, the customer has no options but to wait until the SaaS provider makes new features available. This limits the customer's ability to implement the functionality they desire. Accordingly, improvements are needed.

### SUMMARY

A cloud-based communication platform provides customizable communication services for its customers. The communication services may include a variety of cloud-based communication services, such as facilitating communication sessions (e.g., phone calls, video calls, messaging), managing incoming communication requests, routing communications, providing communication services (e.g., transcription, translation), logging data associated with communication sessions, and the like. The communication services provided by the cloud-based communication platform may be customized by each customer to meet each customer's specific needs. For example, the cloud-based communication platform may provide a base set of features and functionality, which each customer may choose to implement as desired.

While the set of features and functionality provided by the cloud-based communication platform may be sufficient for some customers, other customers may wish to implement features and functionality that are not yet provided by the cloud-based communication platform. To allow these customers to quickly implement the features and functionality they desire, the cloud-based communication platform provides a voice extension framework that allows customers to develop and implement additional features and functionality that are not provided by the cloud-based communication platform. The voice extension framework provides a standardized voice extension Application Programming Interface (API) that can be used to develop voice extensions that extend the base set of features and functionality provided by the cloud-based communication platform. A voice extension is a piece of software that may be implemented into the communication services provided by the cloud-based communication platform to implement a new feature or functionality that extends the communication services provided by the cloud-based communication platform.

Once developed, the voice extension (e.g., piece of software) is added to an extension repository maintained by the cloud-based communication platform, where it may be invoked (e.g., called) to provide the additional feature or functionality. For example, the voice extension may be invoked through use of an extension name designated to the voice extension.

The voice extension framework provides for development of a variety of types of voice extensions. For example, the voice extension framework provides for call processing/media session extensions. Call processing/media session extensions can be invoked at initiation of a communication session and/or during an active communication session. Once invoked, a call processing/media session extension creates an active voice extension session in which functionality of the communication session is managed by the voice extension during the duration of the active voice extension session. Upon conclusion of the voice extension session, functionality of the communication session can be returned to a previous or different state. For example, a call processing/media session extension that provides functionality for securely capturing sensitive information may be invoked during an active communication between a user and agent. Once invoked, the call processing/media session extension generates an active voice extension session in which the user is connected to a secure information collection system while the agent is placed on hold. The secure information collection system collects the sensitive information from the user, after which the active voice extension session is terminated. The communication session then resumes in its previous state in which the user is connected with the agent.

Another type of voice extension provided by the voice extension framework is a media stream extension. A media stream extension allows for a stream of media being transmitted as part of an active communication session to be forked to a specified endpoint or service. Forking the media stream causes the media or a portion of the media being transferred as part of the communication session to be streamed to the designated destination while operation of the communication session remains unaffected. A media stream extension allows the forked media to be processed outside of the communication session for any desired purpose. For example, the streamed media can be processed to generate a transcription of a conversation between participants of the communication session, stored for recording purposes, and the like.

Another type of voice extension provided by the voice extension framework is a media filter extension. A media filter extension allows for media filters to be added and/or removed from a communication session. This allows for modifying the in/out stream of media in a filter chain per communication session. For example, a media filter extension may be invoked at initiation or during an active communication session to filter out a specified type of data from the media stream based on a customer's specific needs.

Another type of voice extension provided by the voice extension framework is a Dual-tone multi-frequency (DTMF) extension. A DTMF extension allows for functionality to be created based on a DTMF event. For example, the DTMF extension may employ a listener for a specified DTMF event and cause a corresponding action to be performed in response to the detected DTMF event.

Another type of voice extension provided by the voice extension framework is a fire and forget extension. In contrast to other types of voice extensions that affect the flow of the communication session, a fire and forget extension simply calls a service. For example, the fire and forget extension may call the service to send a notification, provide analytics, etc.

The voice extension framework defines a voice extension API that is used to develop voice extensions. The voice extension API defines a set of functions and procedures allowing the creation of a voice extension, such as by defining the proper syntax, variables, commands, etc., that are used to perform the desired functionality. For example, the voice extension API defines the commands used to utilize existing functionality, communication with other services or applications, transmit and receive data, etc. The voice extension API may also define how to invoke a voice extension.

Once developed, a voice extension may be implemented by the cloud-based communication platform to extend the features and functionality of the communication services provided by the cloud-based communication platform. For example, the voice extension (e.g., piece of software) is added to an extension repository maintained by the cloud-based communication platform.

The voice extension may be invoked (e.g., called) from the extension repository by a software application utilizing the functionality of the cloud-based communication platform. For example, an extension name may be designated to the voice extension and included into the software application to invoke the voice extension at a desired time and/or under desired condition during execution of the software application. For example, the software application may cause a command including the extension name and potentially one or more software variables to be transmitted to the cloud-based communication platform. Upon executing a command including an extension name, the cloud-based communication platform accesses the voice extension (e.g., piece of software) identified by the extension name from the extension repository and causes execution of the voice extension.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system for providing a programmable voice extension framework to extend the features of a cloud-based communication platform, according to some example embodiments.

FIG. 2 is a block diagram of a cloud-based communication platform, according to some example embodiments.

FIG. 3 shows communications in a system for implementing a voice extension, according to some example embodiments.

FIGS. 4A and 4B show communications in a system 400 for managing a communication request, according to some example embodiments.

FIG. 5 is a block diagram showing signaling within a cloud-based communication platform providing programmable voice extensions, according to some example embodiments.

FIG. 6 shows communications in a system for implementing a voice extension session, according to some example embodiments.

FIG. 7 shows communications in a system for implementing a fire and forget extension, according to some example embodiments.

FIG. 8 shows communications in a system for implementing a media stream extension, according to some example embodiments.

FIG. 9 is a flowchart showing a method for providing a programable voice extension that extends a base set of features and functionality provided by a cloud-based communication platform, according to some example embodiments.

FIG. 10 is a block diagram illustrating components of a machine, according to some example embodiments, able to read instructions from a machine-readable medium (e.g., a machine-readable storage medium) and perform any one or more of the methodologies discussed herein.

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

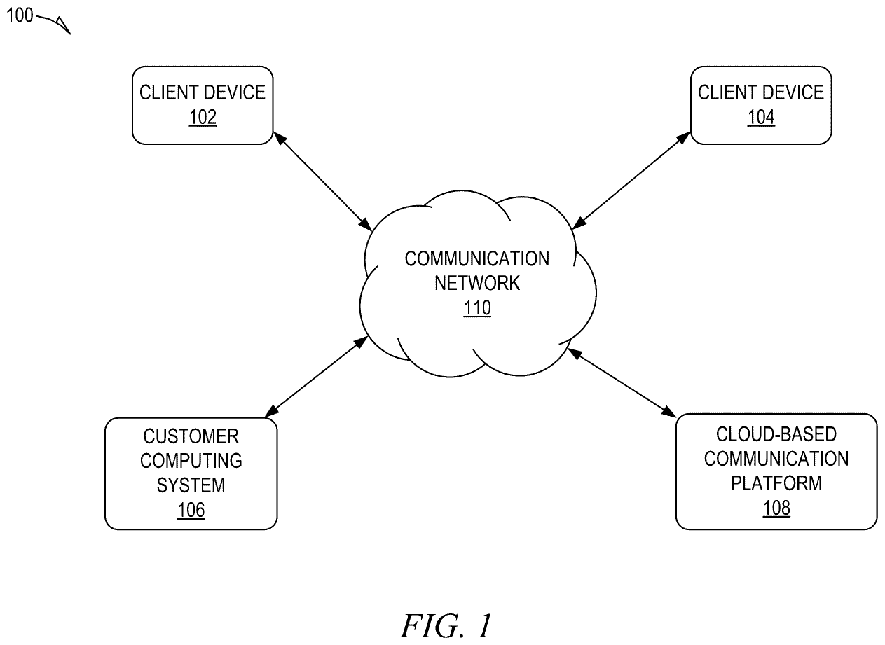

FIG. 1 shows an example system 100 for providing a programmable voice extension framework to extend the features of a cloud-based communication platform, according to some example embodiments. As shown, multiple devices (i.e., client device 102, client device 104, customer computing system 106, and cloud-based communication platform 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

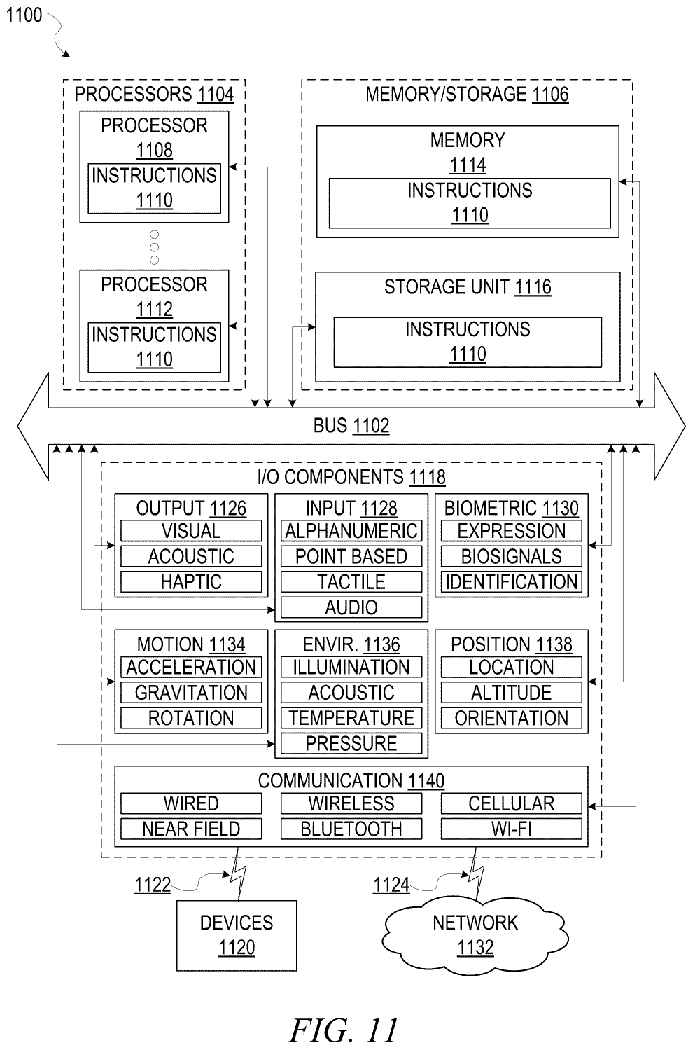

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 1100 shown in FIG. 11.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

The customer computing system 106 is one or more computing devices associated with a customer of the cloud-based communication platform 108. A customer may be any type of a person, entity, business, or the like, that utilizes the communication functionality of the cloud-based communication platform. For example, a customer may be a bank, retail store, restaurant, and the like.

In some embodiments, a customer may provide an online service that may be accessed by users via the communication network 110. In these types of embodiments, the customer computing system 106 may facilitate functioning of the provided online service. For example, users may use the client devices 102 and 104 that are connected to the communication network 110 to interact with the customer computing system 106 and utilize the online service. The online service may be any type of service provided online, such as a ride-sharing service, reservation service, retail service, news service, etc.

Although the shown system 100 includes only two client devices 102, 104 and one customer computing system 106, this is only for ease of explanation and is not meant to be limiting. One skilled in the art would appreciate that the system 100 can include any number of client devices 102, 104 and/or customer computing systems 106. Further, the customer computing system 106 may concurrently accept connections from and interact with any number of client devices 102, 104. The customer computing system 106 may support connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the customer computing system 106 via a client-side application installed on the client devices 102 and 104. In some embodiments, the client-side application includes a component specific to the online service provided by the customer computing system 106. For example, the component may be a stand-alone application, one or more application plug-ins, and/or a browser extension. However, the users may also interact with the customer computing system 106 via a third-party application, such as a web browser, that resides on the client devices 102 and 104 and is configured to communicate with the online service 106. In either case, the client-side application presents a user interface (UI) for the user to interact with the customer computing system 106 to utilize the provided online service. For example, the user interacts with the customer computing system 106 via a client-side application integrated with the file system or via a webpage displayed using a web browser application.

The cloud-based communication platform 108 provides communication services for multiple accounts of the cloud-based communication platform 108. Each account may be associated with a different customer of the cloud-based communication platform 108 (e.g., individual user, set of users, company, organization, online service, etc.). The cloud-based communication platform 108 may provide a variety of cloud-based communication services, such as facilitating communication sessions (e.g., phone calls, messaging, and the like) between endpoints (e.g., client devices), managing incoming communication requests, routing communication requests to an appropriate endpoint, logging data associated with communication sessions, etc. A communication session is any type of communication between two or more client devices 102, 104. For example, a communication session may be a synchronous communication session, such as a voice communication session (e.g., phone call), video communication session (e.g., video conference), and the like. A communication session may also be an asynchronous communication session, such as text communication, chat session, and the like.

The cloud-based communication platform 108 may allocate contact identifiers (e.g., phone numbers, URLs, and the like) to customers for use in facilitating communications. Communications directed to the contact identifiers are received and managed by the cloud-based communication platform 108 according to configurations selected by the customer. For example, the customer may designate an allocated contact identifier to a specific client device 102 causing communications directed to the contact identifier to be routed by the cloud-based communication platform 108 to its designated client device 102. As another example, the customer may designate an allocated contact identifier to a customer call center. As a result, the cloud-based communication platform 108 may route communications directed to the allocated endpoint to one of the customer's available call center agents.

The cloud-based communication platform 108 may also provide customers with an Application Programing Interface (API) that enables the customers to programmatically communicate with and utilize the functionality of the cloud-based communication platform 108. The API may include specific API commands to invoke specified functionality of the cloud-based communication platform 108. For example, the API may define the syntax and format for the API command, including the parameters to include in the API command to initiate the desired functionality, such as initiating a communication session (e.g., phone call, chat session), transmitting an email message, and the like.

A customer may use the API to directly communicate with and utilize the communication services provided by the cloud-based communication platform 108. For example, a customer may use the API to transmit API commands from the customer computing system 106 to the cloud-based communication platform 108 to cause performance of specified functionality, such as initiating a communication session, transmitting an email, and the like.

A customer may also use the API provided by the cloud-based communication platform 108 to incorporate the communication services provided by the cloud-based communication platform 108 into the customer's application or website. For example, the customer may include API commands from the API into the source code of the programming application and/or website to cause the application and/or website to communicate with the cloud-based communication platform 108 to provide communication services provided by the cloud-based communication platform 108.

As an example, a customer that provides an online service such as a ride sharing application may utilize the communication services provided by the cloud-based communication platform 108 to enable users and drivers of the ride sharing application to communicate with each other. For example, the ride sharing application may include a user interface element that may be selected by a user to initiate a communication session with their driver. Selection of the user interface element may cause the customer computing system 106 to transmit an API command to the cloud-based communication platform 108 to initiate a communication session between client devices 102, 104 of the user and driver. Similarly, a customer that provides a dating application may utilize the communication services provided by the cloud-based communication platform 108 to enable users of the dating application to communicate with each other, such as by sending messages, initiating a call, and the like.

Users of the application may not have knowledge that the communication services they are using through the application are being facilitated by the cloud-based communication platform 108. That is, the communication services may be presented as being a part of the application itself rather than provided by the cloud-based communication platform 108. In this way, the communication services facilitated by the cloud-based communication platform 108 are provided as a SaaS.

The cloud-based communication platform 108 enables customers to configure performance of the communication services provided by the cloud-based communication platform 108. For example, the cloud-based communication platform 108 allows its customers to configure a set of communication instructions dictating actions to be performed by the cloud-based communication platform 108. For example, a customer may configure a set of communication instructions to be executed by the cloud-based communication platform 108 in response to the cloud-based communication platform 108 receiving an incoming communication associated with the customer. As another example, a customer may transmit a communication to the cloud-based communication platform 108 to execute a set of communication instructions.

The set of communication instructions may include individual commands that dictate the actions to be performed by the cloud-based communication platform 108. For example, a customer may provide a set of communication instructions dictating actions to be performed by the cloud-based communication platform 108 in response to receiving an incoming communication request (e.g., incoming call) directed to a contact identifier (e.g., phone number) allocated to the customer's account, such as directing the incoming communication to a specified client device 102. As another example, the set of communication instructions may include commands to transmit notifications to a specified destination or initiating a service in relation to an established communication session.

The set of communication instructions may be a programming script that the cloud-based communication platform 108 executes to perform the functionality desired by the customer. The programming script may be written in a proprietary scripting language (e.g., TwiML) provided by the cloud-based communication platform 108 for use by its customers. Alternatively, the programming script may be a third-party scripting language. In either case, the cloud-based communication platform 108 may provide an API and/or library defining specific commands that can be used by customers for invoking a set of features and functionality provided by the cloud-based communication platform 108. Accordingly, a customer of the cloud-based communication platform 108 uses the scripting language to generate a set of communication instructions to cause the cloud-based communication platform 108 to perform the specified actions desired by the customer, such as connecting an incoming communication to a specified destination client device 102, invoking a feature provided by the cloud-based communication platform 108, and the like.

In some embodiments, the set of communication instructions may be provided to the cloud-based communication platform 108 along with an incoming communication, such as an incoming communication request received from a customer computing system 106. As another example, a customer may upload a set of communication instructions to the cloud-based communication platform 108 to be associated with the customer's account and/or specific endpoint identifiers allocated to the customer. As another example, the customer may provide the cloud-based communication platform 108 with a resource identifier (e.g., Uniform Resource Identifier (URI)) that identifies a network location of the set of communication instructions.

In any case, the cloud-based communication platform 108 accesses a set of communication instructions associated with an incoming communication request and executes the set of communication instructions to provide the functionality desired by the customer. In this way, the cloud-based communication platform 108 allows for customization of the features and functionality it provides to its customers. For example, a customer may configure the set of communication instructions as desired to leverage the desired features and functionality provided by the cloud-based communication platform 108. Accordingly, the communication services provided by the cloud-based communication platform 108 may vary based on each customer's specific needs.

While the set of features and functionality provided by the cloud-based communication platform 108 may be sufficient for some customers, other customers may wish to implement features and functionality that are not yet provided by the cloud-based communication platform 108. To allow these customers to quickly implement the features and functionality they desire, the cloud-based communication platform 108 provides a voice extension framework that allows customers to develop and implement additional features and functionality that are not provided by the cloud-based communication platform 108. The voice extension framework provides a standardized voice extension Application Programming Interface (API) that can be used by customers to develop voice extensions that extend the base set of features and functionality provided by the cloud-based communication platform 108. A voice extension is a piece of software that may be implemented into the communication services provided by the cloud-based communication platform 108 to implement a new feature or functionality that extends the communication services provided by the cloud-based communication platform.

A customer that has developed a voice extension, may upload the voice extension (e.g., piece of software) to the cloud-based communication platform 108, where it is added to an extension repository maintained by the cloud-based communication platform 108. The voice extension may then be invoked (e.g., called) to provide the additional feature or functionality. For example, the voice extension may be invoked within a set of communication instructions through use of an extension name designated to the voice extension. During execution of a set of communication instructions that includes an extension name, the cloud-based communication platform 108 accesses the voice extension corresponding to the extension name from the extension repository and then executes the software code to provide the voice extension functionality.

The voice extension framework provides for development of a variety of types of voice extensions. For example, the voice extension framework provides for call processing/media session extensions. Call processing/media session extensions can be invoked at initiation of a communication session and/or during an active communication session. Once invoked, a call processing/media session extension creates an active voice extension session in which functionality is managed by the voice extension during the duration of the active voice extension session. Upon conclusion of the voice extension session, functionality of the communication session can be returned to a previous or different state. For example, a call processing/media session extension that provides functionality for securely capturing sensitive information may be invoked during an active communication between a user and agent, causing generation of an active voice extension session in which the user is connected to a secure information collection system while the agent is placed on hold. The secure information collection system collects the sensitive information from the user, after which the active voice extension session is terminated, and the communication session resumes in its previous state in which the user is connected with the agent.

Another type of voice extension provided by the voice extension framework is a media stream extension. A media stream extension allows for a stream of media being transmitted as part of an active communication session to be forked to a specified endpoint or service. Forking the media stream causes the media or a portion of the media being transferred as part of the communication session to be streamed to the designated destination while operation of the communication session remains unaffected. A media stream extension allows the forked media to be processed outside of the communication session for any desired purpose. For example, the streamed media can be processed to generate a transcription of a conversation between participants of the communication session, stored for recording purposes, and the like.

Another type of voice extension provided by the voice extension framework is a media filter extension. A media filter extension allows for media filters to be added and/or removed from a communication session. This allows for modifying the in/out stream of media in a filter chain per communication session. For example, a media filter extension may be invoked at initiation or during an active communication session to filter out a specified type of data from the media stream based on a customer's specific needs.

Another type of voice extension provided by the voice extension framework is a Dual-tone multi-frequency (DTMF) extension. A DTMF extension allows for functionality to be created based on a DTMF event. For example, the DTMF extension may employ a listener for a specified DTMF event and cause a corresponding action to be performed in response to the detected DTMF event.

Another type of voice extension provided by the voice extension framework is a fire and forget extension. In contrast to other types of voice extensions that affect the flow of the communication session, a fire and forget extension simply calls a service. For example, the fire and forget extension may call the service to send a notification, provide analytics, etc.

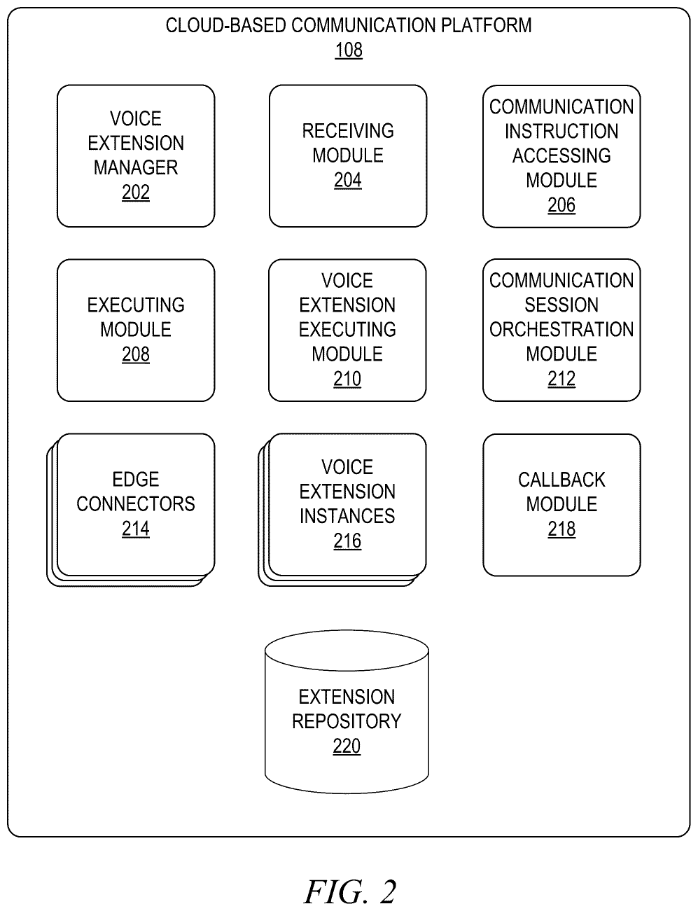

FIG. 2 is a block diagram of a cloud-based communication platform, according to some example embodiments To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the cloud-based communication platform 108 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the cloud-based communication platform 108 includes a voice extension manager 202, a receiving module 204, a communication instruction accessing module 206, an executing module 208, a voice extension executing module 210, a communication session orchestration module 212, edge connectors 214, voice extension instances 216, callback module 218, and extension repository 220.

The voice extension manager 202 provides functionality that enables customers to utilize the voice extension framework provided by the cloud-based communication platform 108. That is, the voice extension framework enables customers to develop and implement voice extensions providing additional features and functionality that extend a base set of features and functionality provided by the cloud-based communication platform 108. For example, the voice extension framework provides a standardized voice extension API, programming libraries, documentation, and the like, which customers may use to develop voice extensions that provide functionality and features beyond the base set of features and functionality provided by the cloud-based communication platform 108. A voice extension is a piece of software that is implemented into the communication services provided by the cloud-based communication platform 108 to provide a new feature or functionality that extends the communication services provided by the cloud-based communication platform 108.

The voice extension manager 202 may provide a user interface that allows customers to access resources, such as the programming libraries, APIs, documentation, development tools, testing tools, and the like, used to develop and implement a voice extension. For example, the resources may define syntax, parameters, features, and the like, for developing a voice extension.

The user interface may also enable customers to upload a developed voice extension to the cloud-based communication platform 108. The voice extension manager 202 stores the uploaded voice extension in the extension repository 220, where the voice extension may then be invoked by customer to utilize the feature or functionality provided by the voice extension.

A voice extension may be invoked using an extension name and/or extension identifier assigned to the voice extension. For example, a customer provides the cloud-based communication platform 108 with a communication instruction including a command using the extension name and/or extension identifier. Execution of a command including an extension name and/or extension identifier causes the cloud-based communication platform 108 to query the extension repository 220 for the voice extension corresponding to the extension name and/or extension identifier. The cloud-based communication platform 108 may then execute the voice extension to provide its related functionality.

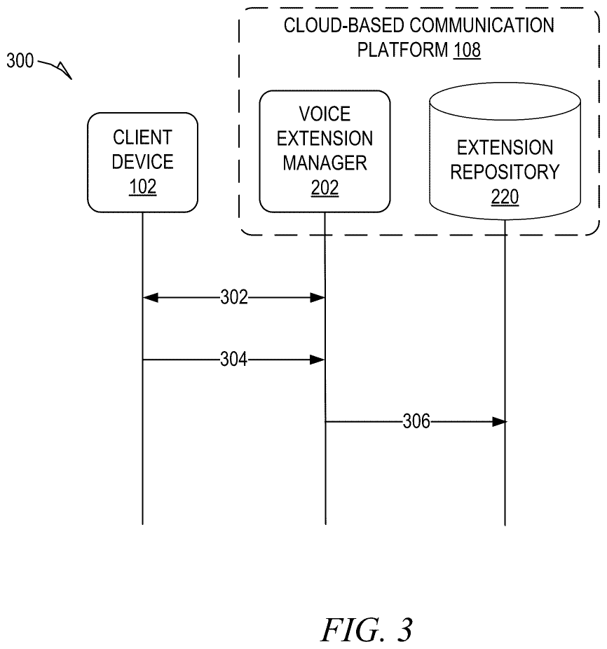

FIG. 3 shows communications in a system 300 for implementing a voice extension, according to some example embodiments. As shown, a customer may use a client device 102 to interact 302 with the voice extension manager 202. The voice extension manager 202 may provide a user interface enabling the customer to utilize the voice extension framework provided by the cloud-based communication platform 108. For example, the user interface may enable customers to access materials and resources used for developing a voice extension, such as the voice extension API, programming libraries, documentation, and the like. The voice extension manager 202 may also provide development tools and/or testing tools that allow customers to develop and test their voice extensions prior to implementation. Accordingly, the interactions 302 between the client device 102 and the voice extension manager 202 may be performed to access the resources provided by the voice extension manager 202.

A customer may also use their client device 102 to upload 304 a completed voice extension to the cloud-based communication platform 108. The voice extension manager 202 receives the upload 304 of the voice extension and stores 306 the voice extension in the extension repository 220, where it may then be invoked in relation to communication services provided by the cloud-based communication platform 108 to provide its related functionality.

Returning to the discussion of FIG. 2, the receiving module 204 manages receiving of incoming communication requests. A communication request is a request to perform some communication functionality. For example, a communication request may be a request to establish a communication session, (e.g., initiate a phone call, transmit a message), return specified data, initiate a service, and the like. A communication request may be initiated by a customer computing system 106 and/or a client device 102. For example, the receiving module 204 may receive an incoming communication request from a customer computing system 106 associated with a customer of the cloud-based communication platform 108. In this type of embodiment, the incoming communication request may be initiated programmatically, such as by using an Application Programming Interface (API) command. For example, the cloud-based communication platform 108 may provide customers with an API to communicate with and utilize the functionality of the cloud-based communication platform 108. The provided API includes individual API commands for communicating with the cloud-based communication platform 108, such as an API command to initiate a communication session, end a communication session, invoke a feature or service, request data, and the like.

The customer computing system 106 may transmit a communication request to the cloud-based communication platform 108 in response to receiving a request from a user of an application provided by the customer. For example, the application may include functionality that enables its users to initiate communication functionality such as initiating a call, sending a message, and the like. Examples of this include a ride-sharing application that enables customers to message their assigned drivers, a banking application that enables users to initiate chat sessions with agents, a travel application that enables users to initiate a call with a call center agent, and the like. A user of a customer application may use a client-side application (e.g., app, web browser, etc.) executing on a client device 102 to communicate with the customer computing system 106 and utilize the functionality of the application, including communication functionality provided by the cloud-based communication platform 108. For example, the user may select a user interface element, such as a button, provided in the customer application to initiate a communication session. Selection of the user interface element may cause the client device 102 to transmit a command to the customer computing system 106. The customer computing system 106 may then transmit a subsequent communication request to the cloud-based communication platform 108 to initiate a communication session.

The customer computing system 106 may also transmit a communication request to the cloud-based communication platform 108 independently (e.g., not as a result of having received a command from a client device 102). For example, a customer may wish to initiate a call with a user, transmit messages to users, initiate a feature or functionality, request specified data, and the like. In this type of situation, the customer computing system 106 may transmit a communication request to the cloud-based communication platform 108 to cause the desired action.

In some embodiments, a communication request may be received from a client device 102 via a communication provider network. For example, a user may use a contact identifier (e.g., phone number) allocated to a customer of the cloud-based communication platform 108 to initiate a communication session. That is, the user may use the phone number or other contact identifier to initiate a phone call or transmit a text message. Accordingly, the incoming communication request may be received from the communication provider network associated with the client device 102, such as via a public switched telephone network (PSTN) or VoIP.

The receiving module 204 communicates with the other modules of the cloud-based communication platform 108 to process communication requests. For example, the receiving module 204 may communicate with the communication instruction accessing module 206 and/or the executing module 208 to process an incoming communication request.

The executing module 208 executes communication instructions to provide functionality specified by the customer. For example, the communication instructions may be in the form of API commands and/or a programming script (e.g., TwiML) provided by the cloud-based communication platform 108 for use by customers. In some embodiments, a communication request received by the receiving module 204 may include the communication instructions. In this type of situation, the receiving module 204 passes the communication instructions to the executing module 208 to be executed.

In some embodiments, the communication instructions may be hosted at a remote network location. For example, the set of communication instructions may be maintained at a network location managed by a customer computing system 106. In this type of embodiment, the receiving module 204 communicates with the communication instruction accessing module 206 to access the set of communication instructions and provide the communication instructions to the receiving module 204 and/or executing module 208. The communication instruction accessing module 206 accesses the set of communication instructions using a resource identifier, such as a Uniform Resource Identifier (URI), that identifies the network location at which the set of communication instructions may be accessed. The communication instruction accessing module 206 uses the resource identifier to transmit a request, such as a Hypertext Transfer Protocol (HTTP) request, to the network location for the set of communication instructions.

In some embodiments, the resource identifier may be included in the communication request received by the receiving module 204. The receiving module 204 may provide the received resource identifier to the communication instruction accessing module 206, which the communication instruction accessing module 206 then uses to access the set of communication instructions.

In some embodiments, the resource identifier may be associated with a customer account and/or contact identifier. For example, a customer may have established a set of communication instructions for handling communication requests directed to contact identifiers and/or individual contact identifiers allocated to the customer. The customer may provide a resource identifier for accessing the set of communication instructions to the cloud-based communication platform 108, which may be stored and associated with the customer's account and/or specified contact identifiers.

In this type of embodiment, the receiving module 204 may provide the communication instruction accessing module 206 with data used to identify the appropriate resource identifier for a communication request. For example, the receiving module 204 may provide the communication instruction accessing module 206 with the contact identifier (e.g., phone number) associated with the communication request, a unique identifier assigned to the customer account, and the like. The communication instruction accessing module 206 may use the provided data to identify the resource identifier associated with the contact identifier and/or customer account, which the communication instruction accessing module 206 then uses to access the set of communication instructions.

In any case, the communication instruction accessing module 206 uses the resource identifier to transmit a request, such as a HTTP request, to the network location, which in response returns the set of communication instructions. In some embodiments, the set of communication instructions may be static, such that the same setoff communication instructions are returned by the network location for each received request.

Alternatively, the set of communication instructions may be dynamically generated based on the received request. For example, the communication instruction accessing module 206 may embed parameters into the request transmitted to the network location, which are used to dynamically generate the set of communication instructions. In this type of embodiments, the resource identifier may provide a template for generating the request for the set of communication instructions. Accordingly, the communication instruction accessing module 206 gathers the data to be included in the request as parameters, which are populated into the resource identifier template. The communication instruction accessing module 206 then transmits the resulting request to the network location. The parameters may include any of a variety of data, such as data describing a state of an active communication session, a contact identifier to which the communication request is directed, text of message being transmitted, and the like.

As explained earlier, the executing module 208 executes the individual instructions and/or commands included in the set of communication instructions. In this way, the cloud-based communication platform 108 allows for customization of the features and functionality it provides to its customers. For example, a customer may configure the set of communication instructions as desired to leverage the desired features and functionality provided by the cloud-based communication platform 108. Accordingly, execution of the set of communication instructions by the executing module 208 provides customized performance of the communication services provided by the cloud-based communication platform 108 according to the customer's specific needs.

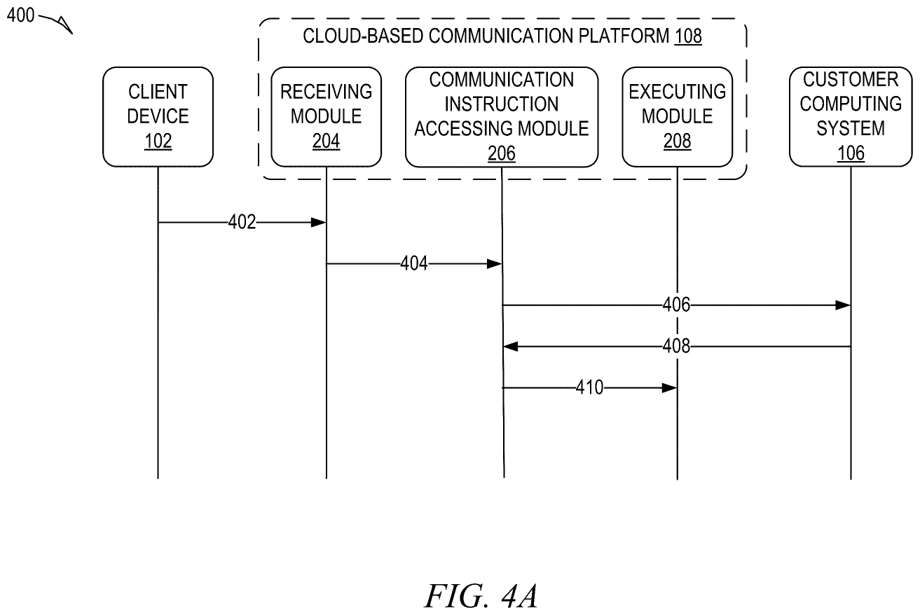

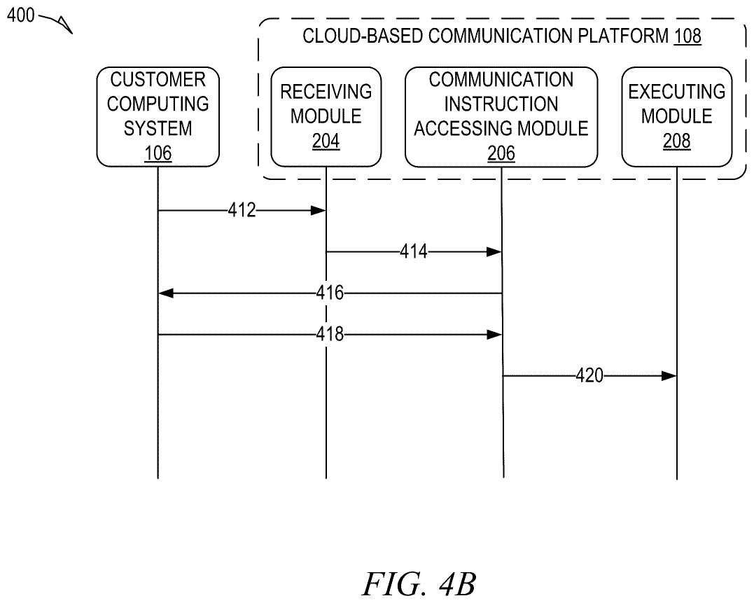

FIGS. 4A and 4B show communications in a system 400 for managing a communication request, according to some example embodiments. FIG. 4A shows an embodiment in which the cloud-based communication platform 108 receives a communication request 402 from a client device 102. The communication request 402 is received by the receiving module 204. The communication request 402 may be initiated as a result of a user of the client device 102 using a contact identifier managed by the cloud-based communication platform 108 to initiate a phone call or transmit a text message. The communication request may therefore be received via a communication provider network, such as via a public switched telephone network (PSTN) or VoIP.

The receiving module 204 transmits an instruction 404 to the communication instruction accessing module 206 to access a set of communication instructions associated with the communication request. The instruction 404 may include data, such as the contact identifier associated with the communication request, that the communication instruction accessing module 206 uses to identify the resource identifier for accessing the set of communication instructions. The communication instruction accessing module 206 uses the resource identifier to transmit a request 406 to the customer computing system 106 for the set of communication instructions. The request may include embedded parameters used by the customer computing system 106 to generate the set of communication instructions.

The customer computing system 106 returns 408 the set of communication instructions to the communication instruction accessing module 206. The communication instruction accessing module 206 provides 410 the set of communication instructions received from the customer computing system 106 to the executing module 208. The executing module 208 executes the set of communication instructions to process the communication request 402, thereby providing the customized functionality dictated by the customer.

FIG. 4B shows an embodiment in which the cloud-based communication platform 108 receives a communication request 412 from the customer computing system 106. The communication request 412 is received by the receiving module 204. The communication request 412 may be an API command based on an API provided by the cloud-based communication platform 108.

The receiving module 204 transmits an instruction 414 to the communication instruction accessing module 206 to access a set of communication instructions associated with the communication request 412. The instruction 414 may include data, such as a contact identifier associated with the communication request 412, that the communication instruction accessing module 206 uses to identify the resource identifier for accessing the set of communication instructions. Alternatively, the instruction 414 may include the resource identifier.

The communication instruction accessing module 206 uses the resource identifier to transmit a request 416 to the customer computing system 106 for the set of communication instructions. The request 416 may include embedded parameters used by the customer computing system 106 to generate the set of communication instructions. The customer computing system 106 returns 418 the set of communication instructions to the communication instruction accessing module 206. The communication instruction accessing module 206 provides 420 the set of communication instructions received from the customer computing system 106 to the executing module 208. The executing module 208 executes the set of communication instructions to process the communication request 402, thereby providing the customized functionality dictated by the customer.

Returning to the discussion of FIG. 2, the executing module 208 executes the individual instructions and/or commands included in the set of communication instructions. In this way, the cloud-based communication platform 108 allows for customization of the features and functionality it provides to its customers. For example, a customer may configure the set of communication instructions as desired to leverage the desired features and functionality provided by the cloud-based communication platform 108. Accordingly, execution of the set of communication instructions by the executing module 506 provides customized performance of the communication services provided by the cloud-based communication platform 108 according to the customer's specific needs. For example, the set of communication instructions may include commands to establish a communication session, return specified data, and the like. The executing module 208 may execute the individual commands included in the set of communication instructions in a sequential order using a top-down approach. For example, the executing module 208 may execute the first listed command in the set of communication instructions, followed by the second listed command, and so on.

The executing module 208 communicates with the other modules of the cloud-based communication platform to perform functionality associated with execution of each executed command. For example, the executing module 208 may communicate with the communication session orchestration module 212 to initiate a communication session, transmit a message, and the like. As another example, the executing module 208 may communicate with the callback module 218 to communicate with the customer computing system 106.

The communication session orchestration module 212 orchestrates management of communication sessions facilitated by the cloud-based communication platform 108. For example, the communication session orchestration module 212 generates an instance of an edge connector 214 to facilitate a communication session between various client devices 102, 104. An edge connector 214 facilitates transmission of media (e.g., voice, video, etc.) between client devices 102, 104. For example, an edge connector 214 receives media from each client device 102, 104 participating in the communication session and transmits the received media to the other client devices 102, 104 participating in the communication session. An edge connector 214 provides compatibility with a variety of communication networks and types, such as PSTN, SIP, VoIP, Web Client, and the like.

An edge connector 214 may also manage communications between the client devices 102, 104 and the cloud-based communication platform 108. For example, an edge connector 214 may receive input and/or commands from the client devices 102, 104, such as DTMF signals, API commands, and the like. The edge connector 214 may communicate the received commands and/or inputs to the other various modules and/or components of the cloud-based communication platform 108. Similarly, an edge connector may receive commands from the other various modules and/or components of the cloud-based communication platform 108 and provide the commands to the client device 102, 104 (e.g., API commands).

To initiate a communication session, the communication session orchestration module 212 may generate an instance of an edge connector 214 and provide the edge connector 214 with data identifying the client devices 102, 104 participating in the communication session. The edge connector 214 may use the provided data to communicate with and establish communication channels with the participating client devices 102, 104. The established communication channels allow for the transmission of media between the edge connector 214 and the client devices 102, 104 participating in the communication session.

The callback module 218 facilitates communication from the cloud-based communication platform 108 to a customer computing system 106. For example, the callback module 218 may be used to return state information, metrics, notifications, and the like, to the customer computing system 106. In some embodiments, the callback module 218 may transmit communications using an HTTP callback, although any messaging protocol may be used. The communications returned to the customer computing system 106 may be embedded with state information relating to a communication session, communication service performance, and the like. For example, a communication may be embedded with data identifying occurrence of events in relation to a communication session facilitated by the cloud-based communication platform 108. This allows for customers of the cloud-based communication platform 108 to receive data associated with communication services provided by the cloud-based communication platform 108, which the customer may then use as desired, such as by affecting performance of an application, generating metrics, causing notifications, and the like.

The executing module 208 may also cause execution of a voice extension. As explained earlier, a customer may invoke a voice extension by using a command that includes the extension name and/or extension identifier assigned to the voice extension. For example, the command may be included in a set of communication instructions provided to the executing module 208. When executing a command that includes an extension name and/or extension identifier assigned to a voice extension, the executing module 208 queries the extension repository 220 for the voice extension corresponding to the extension name and/or extension identifier. The executing module 208 receives the voice extension (e.g., piece of software) from the extension repository 220 in response to the query and provides the voice extension to the voice extension executing module 210. The voice extension executing module 210 then executes the voice extension. For example, the voice extension executing module 210 may execute the piece of software (e.g., commands, code, and the like), that define the voice extension, which may cause generation of a voice extension instance 216. A voice extension instance 216 is a software instance that provides the functionality of a voice extension. For example, the voice extension instance 216 may communicate with internal components and/or modules of the cloud-based communication platform 108 (e.g., communication session orchestration module 212, callback module 218, etc.) as well external resources to provide specified functionality.

The voice extension framework provides for development of a variety of types of voice extensions, such as call processing/media session extensions, media stream extension, media filter extension, DTMF extension, and fire and forget extension. Each of these types of voice extensions may provide varying interactions between the modules and/or components of the cloud-based communication platform 108 and be processed differently by the voice extension executing module 210. For example, a call processing/media session extension creates an active voice extension session in which communication functionality is transferred to and managed by the voice extension instance 216 during the duration of the active voice extension session. During this type of active voice extension session, performance of a previously established communication session may be paused or terminated until completion of the voice extension session.

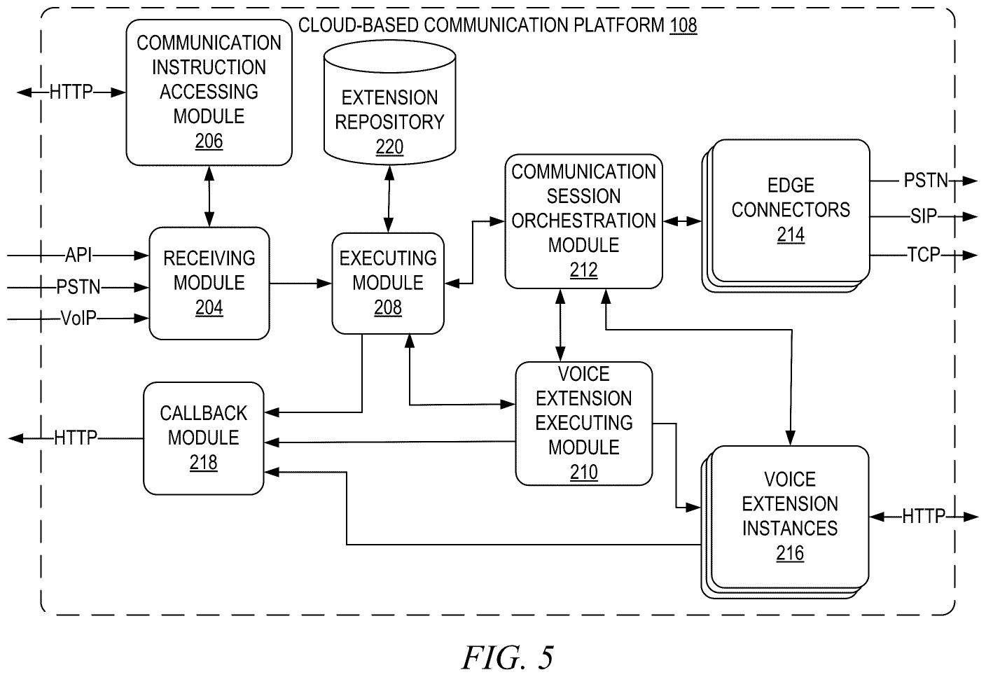

Alternatively, a media stream extension allows for a stream of media being transmitted as part of an active communication session to be forked to a specified endpoint or service. A voice extension instance 216 providing a media stream extension therefore operates concurrently with a communication session. Performance of the cloud-based communication platform 108 when executing various types of voice extensions are discussed in greater detail below in relation to FIGS. 5-8.

FIG. 5 is a block diagram showing signaling within a cloud-based communication platform 108 providing programmable voice extensions, according to some example embodiments. As shown, the receiving module 204 is configured to receive incoming communication requests from external devices (e.g., customer computing system 106, client devices 102, 104). The receiving module 204 can receive a variety of different types of communication requests, such as API commands, incoming calls or messages via a PSTN or VoIP, and the like.

The receiving module 204 can communicate with the communication instruction accessing module 206 and the executing module 208 to process an incoming communication request. The executing module 208 executes communication instructions to provide functionality specified by a customer. For example, the communication instructions may be in the form of API commands and/or a programming script (e.g., TwiML) provided by the cloud-based communication platform 108 for use by customers.

In some embodiments, a communication request received by the receiving module 204 may include the set of communication instructions. In this type of situation, the receiving module 204 passes the communication instructions to the executing module 208 to be executed. Alternatively, the set of communication instructions may be hosted at a remote network location, such as by the customer computing system 106. In this type of situation, the receiving module 204 communicates with the communication instruction accessing module 206 to access the set of communication instructions for processing the incoming communication request. The communication instruction accessing module 206 accesses the set of communication instructions using a resource identifier, such as a URI, that identifies the network location at which the set of communication instructions may be accessed. The communication instruction accessing module 206 uses the resource identifier to transmit a request (e.g., HTTP request) to the network location for the set of communication instructions. The receiving module 204 provides the set of communications instructions returned by the communication instruction accessing module 206 to the execution module 208.

The execution module 208 is configured to communicate with the communication session orchestration module 212, callback mode 218, extension repository 220, and/or voice extension executing module 210. For example, the execution module 208 communicates with the communication session orchestration module 212 to initiate a communication session, transmit a message to a client device 102, initiate a service in relation to a communication session, request data (e.g., state data) associated with a communication session, and the like.

As shown, the communication session orchestration module 212 may generate and communicate with multiple edge connectors 214 to facilitate communication sessions between client devices 102, 104 and/or facilitate communications between the client devices 102, 104 and other module/components of the cloud-based communication platform 108. Each edge connector 214 facilitates transmission of media (e.g., voice, video, etc.) between client devices 102, 104 and provides compatibility with a variety of communication networks and types, such as PSTN, SIP, VoIP, Web Client, and the like.

Each edge connector 214 may also manage communications between the client devices 102, 104 and the other modules and/or components of the cloud-based communication platform 108. For example, an edge connector 214 may receive input and/or commands from the client devices 102, 104, such as DTMF signals, API commands, and the like. The edge connector 214 may communicate the received commands and/or inputs to the communication session orchestration module 212, which may then transmit the commands and/or input to other modules and/or components of the cloud-based communication platform 108, such as the the executing module 208, voice extension executing module 210 and voice extension instances 216. Similarly, the communication session orchestration module 212 may receive commands from the other various modules and/or components of the cloud-based communication platform 108 and provide the commands to an edge connector 214, which in turn communicates with the client device 102, 104 (e.g., API commands).

The execution module 208 communicates with the callback module 218 to transmit data to a customer computing system 106. In some embodiments, the execution module 208 may provide the executing module 208 with data to transmit to the customer computing system 106, such as state data associated with a communication session (e.g., a current status of a communication session). For example, the executing module 208 may receive data describing a communication session from the communication session orchestration module 212 and pass the state data to the callback module 218 to be returned to the customer computing system 106.

The executing module 208 communicates with extension repository 220 to execute a command that includes an extension identifier associated with a voice extension. The executing module 208 uses the extension identifier to access a set of code (e.g., programming code) corresponding to the extension identifier from the extension repository 220. For example, the executing module 208 queries the extension repository 220 based on the extension identifier. The executing module 208 provides the set of code returned from the extension repository 220 to the voice extension executing module 210 to cause execution of a voice extension.

The voice extension executing module 210 executes the set of code to provide the functionality of the voice extension. In some cases, this may include initiating a voice extension instance 216 that provides the functionality of the voice extension. A voice extension instance 216 is an executed software instance that provides the functionality of the voice extension. For example, the voice extension instance 216 may communicate with external computing systems to provide specified functionality, such as by transmitting HTTP requests using a URI associated with the external computing system. A voice extension instance 216 may also communicate with the other modules and/or components of the cloud-based communication platform 108. For example, the voice extension instance 216 may communicate with the communication session orchestration module 212 to initiate communication session, request data related to a communication session, receive input from a communication session (e.g., voice, text, DTMF tone), and the like. The voice extension instance 216 may also communicate with the callback module 218 to cause a callback message to be transmitted to the customer computing system 106.

In some embodiments, the voice extension executing module 210 may provide the functionality of a voice extension without creating a voice extension instance 216. For example, a fire and forget extension may simply call a service without otherwise affecting the flow of the communication services and/or communication session being provided by the cloud-based communication platform 108. In this type of embodiment, the voice extension executing module 210 may communicate directly with other modules and/or components of the cloud-based communication platform 108 to provide the functionality of the voice extension. For example, the voice extension executing module 210 may communicate with the callback module 218 to cause a callback message to be transmitted to the customer computing system 106. As another example, the voice extension executing module 210 may communicate with the communication session orchestration module 212 to initiate a service in relation to a communication session, alter a state of a communication session, transmit data to a client device 102, 104, and the like.

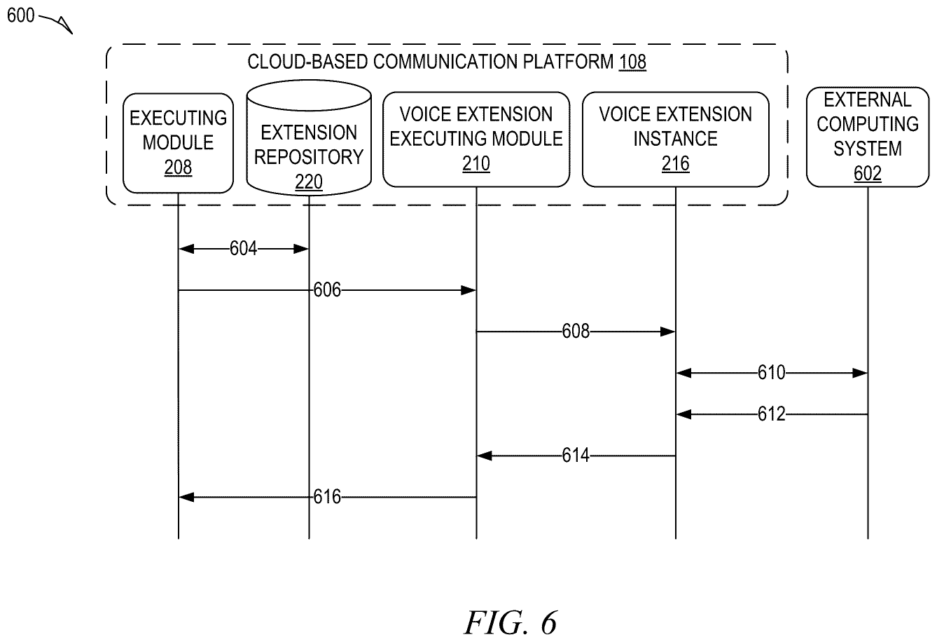

FIG. 6 shows communications in a system 600 for implementing a voice extension session, according to some example embodiments. As shown, the system 600 includes a cloud-based communication platform 108 and an external computing system 602, the cloud-based communication platform 108 includes an executing module 208, an extension repository 220 a voice extension executing module 210 and a voice extension instance 216. The executing module 220 executes communication instructions to provide functionality specified by a customer. This may include providing features and/or functionality that are provided by the cloud-based communication platform 108 as well as features and functionality that are provided by voice extensions developed by customers and/or third parties.

When presented with a command that includes an extension identifier associated with a voice extension, the executing module 208 communicates 604 with the extension repository 220 to access a set of code associated with the extension identifier. The extension identifier may be included in a command executed by the executing module 208. For example, the command may be included in a set of communication instructions associated with a communication request.

The extension identifier identifies a voice extension that has been uploaded to the cloud-based communication platform 108 to extend the features and functionality provided by the cloud-based communication platform 108. For example, the voice extension may provide a feature or functionality that is not included in a base set of features or functionality provided by the cloud-based communication platform 108.

The executing module 208 provides 606 the set of code to the voice extension executing module 210. The voice extension executing module 210 executes the set of code to provide the functionality of the voice extension. As explained earlier, the voice extension framework provides for development of a variety of types of voice extensions, such as call processing/media session extensions, media stream extension, media filter extension, DTMF extension, and fire and forget extension. Each of these types of voice extensions may provide varying interactions between the modules and/or components of the cloud-based communication platform 108 and be processed differently by the voice extension executing module 210. In the example shown in FIG. 6, the voice extension is a call processing/media session extension. A call processing/media session extension creates an active voice extension session in which communication functionality is transferred to and managed by the voice extension instance 216 during the duration of the active voice extension session. During this type of active voice extension session, performance of a previously established communication session may be paused or terminated until completion of the voice extension session.

The voice extension executing module 210 generates 608 the voice extension instance 216. The voice extension instance 216 initiates a voice extension session by communicating 610 with an external computing system 602 to provide the functionality of the voice extension. During the voice extension session, the voice extension instance 216 and the external computing system 602 may provide data back and forth to provide the functionality of the voice extension. For example, the voice extension may provide a service such as an Interactive Voice Response (IVR) service that interacts with a human user through the user of voice and DTMF tones.

To provide this type of service, the voice extension instance 216 may communicate with the other modules of the cloud-based communication platform 108 to gather input from a user, which the voice extension instance 216 then provides to the external computing system 602. For example, the voice extension instance 216 may communicate with the communication session orchestration module 212 to gather voice provided by the user of a client device 102 and/or DTMF input provided by the user of the client device 102.

The voice extension instance 216 provides the received input to the external computing system 602, which in turn may generate instructions for providing a response. For example, the external computing system 602 may return text to the voice extension instance 216 with instructions to play a voice response (e.g., text to speech). Other examples of instructions returned by the external computing system 602 include instructions to modify a state of the communication session, initiate a new communication session, return data to the customer computing system 106, return data to the external computing system 602, and the like. In turn, the voice extension instance 216 may communicate with the other modules of the cloud-based communication platform 108 to cause performance of the instructed functions, such as by communicating with the callback module 218 to return data to a customer computing system 106 and/or the communication session orchestration module 212 to cause playback to a client device 102.

To terminate an extension session, the external computing system 602 transmits 612 a return command to the voice extension instance 216. The return command indicates that the extension session has been completed and that communication functionality should be transferred from the voice extension instance 216 to the executing module 208. In response to the receiving the return command, the voice extension instance 216 may transmit 614 the return command to the voice extension executing module 210. The voice extension instance 216 may then be terminated. The voice extension executing module 210 may transmit 616 the return command to the execution module 208, thereby notifying the executing module 208 that the voice extension session is completed. The executing module 208 may then resume command of communication functionality, such as by executing a next command in the set of communication instructions.

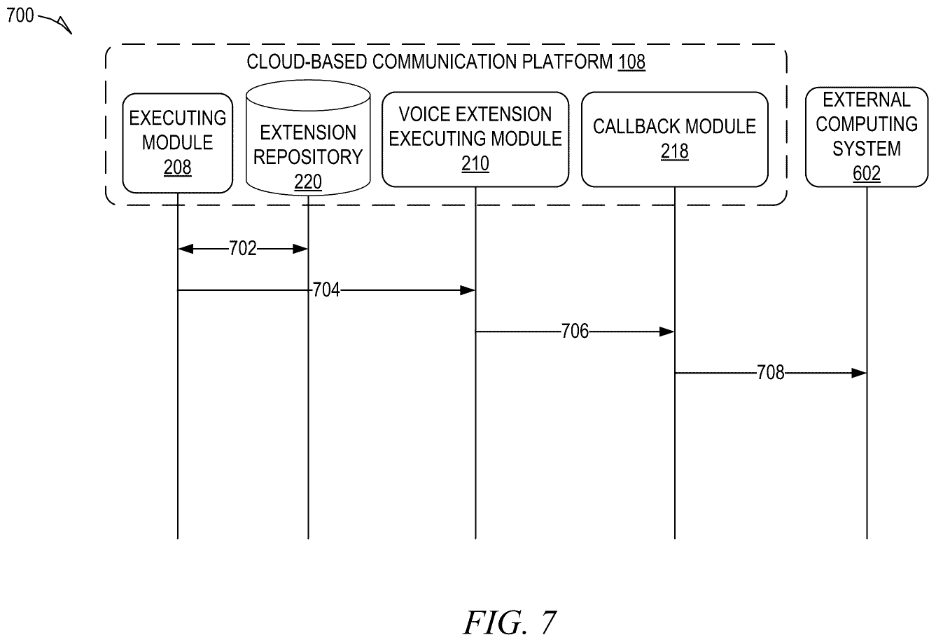

FIG. 7 shows communications in a system 700 for implementing a fire and forget extension, according to some example embodiments. Similar to the system shown in FIG. 6, the executing module 220 communicates 702 with the extension repository 220 to access a set of code associated with the extension identifier. This is performed in response to the executing module 220 being presented with a command that includes an extension identifier associated with a voice extension. The executing module 208 provides 704 the set of code to the voice extension executing module 210. The voice extension executing module 210 executes the set of code to provide the functionality of the voice extension.

In the example shown in FIG. 7, the voice extension is a fire and forget extension. In contrast to other types of voice extensions that affect the flow of a communication session or communication services, a fire and forget extension simply calls a service. For example, the fire and forget extension may call the service to send a notification, provide analytics, etc. The voice extension executing module 210 may therefore execute the first and forget extension without initiating a voice extension instance 216. For example, the voice extension executing module 210 transmits 706 a command to the callback module 218 to cause the callback module 218 to call out to a specified service. The command transmitted 706 to the callback module 218 may include a URI that references an external computing system 602 that provides the service. The callback module 218 uses the URI to generate a HTTP request, which is then transmitted 708 to the external computing system 602. The HTTP request may include embedded data describing communication services or simply operate as a notification and/or alert.

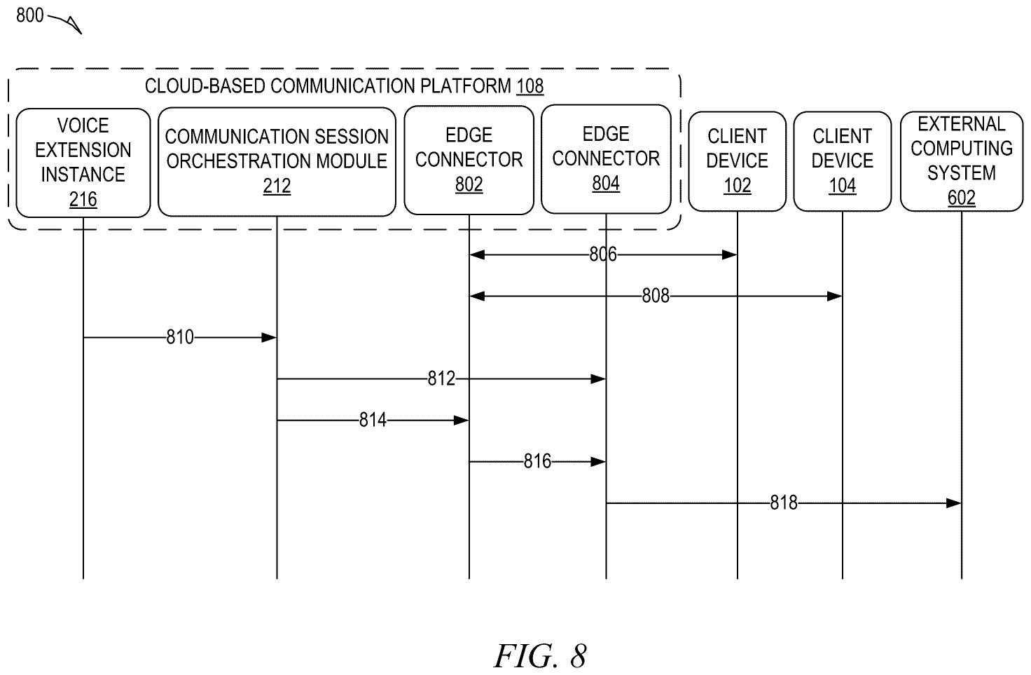

FIG. 8 shows communications in a system 800 for implementing a media stream extension, according to some example embodiments. Although not shown in FIG. 8, the voice extension instance 216 is initiated by the voice extension executing module 210. For example, the voice extension executing module 210 executes a set of code provided to the voice extension executing module 210 by the executing module 208 to provide the functionality of the voice extension.

In the example shown in FIG. 8, the voice extension is a media stream extension. A media stream extension allows for a stream of media being transmitted as part of an active communication session to be forked to a specified endpoint or service. Forking the media stream causes the media or a portion of the media being transferred as part of the communication session to be streamed to the designated destination while operation of the communication session remains unaffected. A media stream extension allows the forked media to be processed outside of the communication session for any desired purpose. For example, the streamed media can be processed to generate a transcription of a conversation between participants of the communication session, stored for recording purposes, and the like.

As shown, the cloud-based communication platform 108 includes an edge connector 802 that is facilitating a communication session between two client devices 102, 104. The edge connector 802 establishes communication paths 806, 808 with each client device 102, 104 to facilitate the transmission of media (e.g., voice, video, etc.) between client devices 102, 104. For example, the edge connector 802 receives media from each client device 102, 104 via the communication path 806, 808 established with the respective client device 102, 104 and communicates the received media to the other client device 102, 104 via the communication path 806, 808 established with the other client device 102, 104.

To initiate the media stream, the voice extension instance 216 transmits a command 810 to the communication session orchestration module 212. The command 810 may include data identifying the communication session from which the media stream is to be established, the external computing system 602 to which the media stream is to be established, the type of media to be included in the media stream, and the like.

In response to receiving the command 810, the communication session orchestration module 212 allocates 812 a new edge connector 804 to facilitate the media stream. The communication session orchestration module 212 provides the edge connector 804 with data identifying the external computing system 602 that is the destination of the media stream and/or the type of media to be included in the media stream. The communication session orchestration module 212 also instructs 814 the edge connector 802 facilitating the communication session to transmit media to the new edge connector 804. This instruction 814 may include data identifying the type of media to be included in the media stream. In response, the edge connector 804 begins a stream 816 of media to the new edge connector. In turn, the new edge connector 804 streams 818 the received media to the external computing system 602.

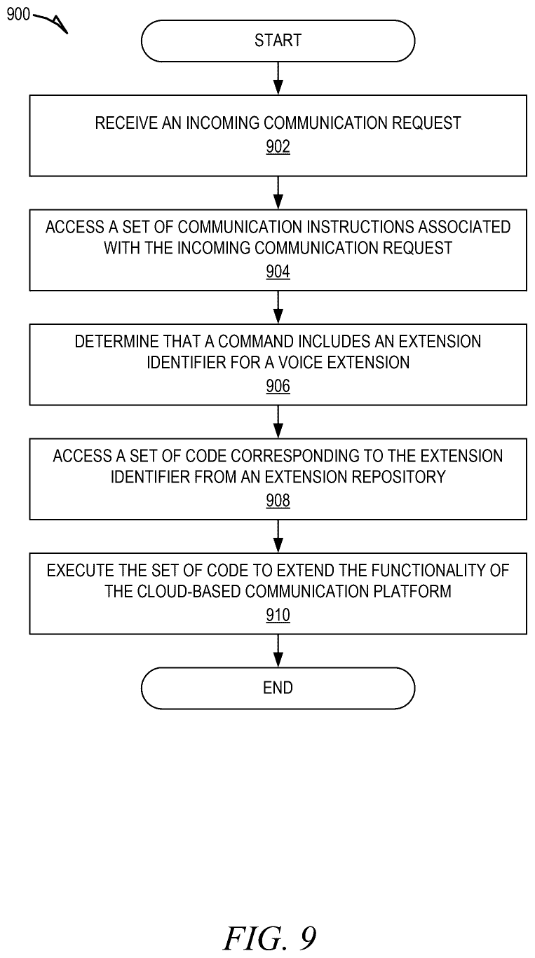

FIG. 9 is a flowchart showing a method 900 for providing a programmable voice extension that extends a base set of features and functionality provided by a cloud-based communication platform 108, according to some example embodiments. The method 900 may be embodied in computer readable instructions for execution by one or more processors such that the operations of the method 900 may be performed in part or in whole by the cloud-based communication platform 108; accordingly, the method 900 is described below by way of example with reference thereto. However, it shall be appreciated that at least some of the operations of the method 900 may be deployed on various other hardware configurations and the method 900 is not intended to be limited to the cloud-based communication platform 108.

At operation 902, the receiving module 204 receives an incoming communication request. A communication request is a request to perform some communication functionality. For example, a communication request may be a request to establish a communication session, (e.g., initiate a phone call, transmit a message), return specified data, initiate a service, and the like. A communication request may be initiated by a customer computing system 106 and/or a client device 102. For example, the receiving module 204 may receive an incoming communication request from a customer computing system 106 associated with a customer of the cloud-based communication platform 108. In this type of embodiment, the incoming communication request may be initiated programmatically, such as by using an API command.

Alternatively, a communication request may be received from a client device 102 via a communication provider network. For example, a user may use a contact identifier (e.g., phone number) allocated to a customer of the cloud-based communication platform 108 to initiate a communication session. That is, the user may use the phone number or other contact identifier to initiate a phone call or transmit a text message. Accordingly, the incoming communication request may be received from the communication provider network associated with the client device 102, such as via a public switched telephone network (PSTN) or VoIP.

The receiving module 204 communicates with the other modules of the cloud-based communication platform 108 to process received communication requests. For example, the receiving module 204 may communicate with the communication instruction accessing module 206 and/or the executing module 208 to process an incoming communication request.

At operation 904, the communication instruction accessing module 206 accesses a set of communication instructions associated with the incoming communication request. The communication instruction accessing module 206 accesses the set of communication instructions using a resource identifier, such as a URI, that identifies the network location at which the set of communication instructions may be accessed. The communication instruction accessing module 206 uses the resource identifier to transmit a request, such as a HTTP request, to the network location for the set of communication instructions.

In some embodiments, the resource identifier may be included in the communication request received by the receiving module 204. Alternatively, the resource identifier may be associated with a customer account and/or contact identifier. For example, a customer may have established a set of commination instructions for handling communication requests directed to contact identifiers and/or individual contact identifiers allocated to the customer. The customer may provide a resource identifier for accessing the set of communication instructions to the cloud-based communication platform 108, which may be stored and associated with the customer's account and/or specified contact identifiers.

In any case, the communication instruction accessing module 206 uses the resource identifier to transmit a request, such as a HTTP request, to the network location, which in response returns the set of communication instructions. The set of communication instructions are provided to the executing module 208, which executes the set of communication instructions to provide functionality specified by the customer.

At operation 906, the executing module 208 determines that a command includes an extension identifier for a voice extension. As explained earlier, a customer may invoke a voice extension by using a command that includes the extension name and/or extension identifier assigned to the voice extension. For example, the command may be included in a set of communication instructions provided to the executing module 208.

At operation 908, the executing module 208 accesses a set of code corresponding to the extension identifier from an extension repository 220. When executing a command that includes an extension name and/or extension identifier assigned to a voice extension, the executing module 208 queries the extension repository 220 for the voice extension corresponding to the extension name and/or extension identifier. The executing module 208 receives the voice extension (e.g., piece of software, code) from the extension repository 220 in response to the query and provides the voice extension to the voice extension executing module 210.

At operation 910, the voice extension executing module 210 executes the set of code to extend the functionality of the cloud-based communication platform. For example, the voice extension executing module 210 may execute the piece of software (e.g., commands, code, and the like), that define the voice extension, which may cause generation of a voice extension instance 216. A voice extension instance 216 is a software instance that provides the functionality of a voice extension. For example, the voice extension instance 216 may communicate with internal component and/or modules of the cloud-based communication platform 108 (e.g., communication session orchestration module 212, callback module 218, etc.) as well external resources to provide specified functionality.

### Software Architecture

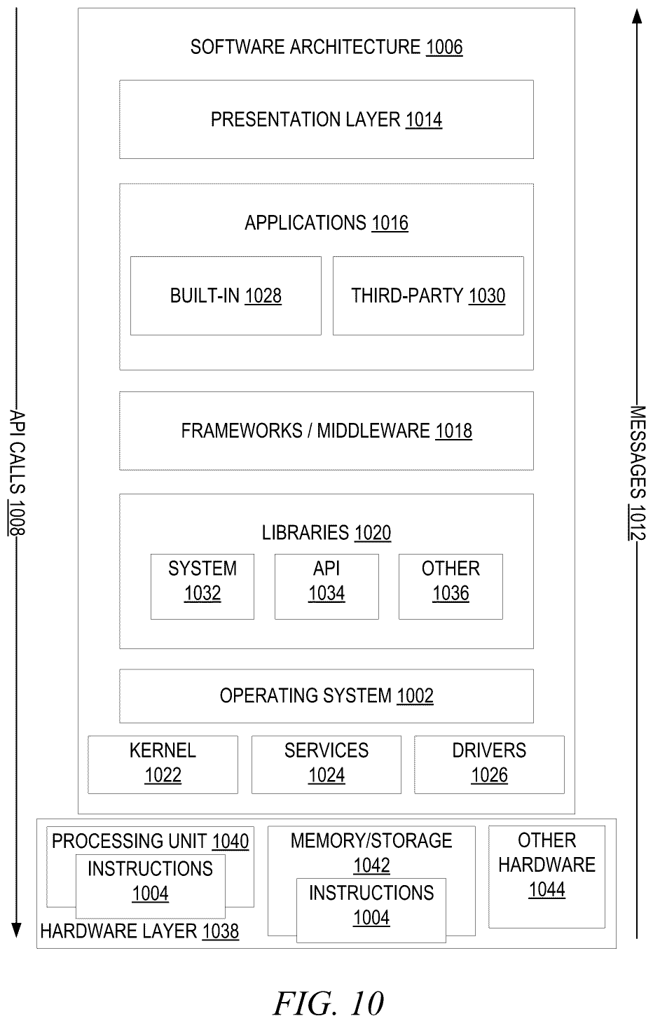

FIG. 10 is a block diagram illustrating an example software architecture 1006, which may be used in conjunction with various hardware architectures herein described. FIG. 10 is a non-limiting example of a software architecture 1006 and it will be appreciated that many other architectures may be implemented to facilitate the functionality described herein. The software architecture 1006 may execute on hardware such as machine 1100 of FIG. 11 that includes, among other things, processors 1104, memory 1114, and (input/output) I/O components 1118. A representative hardware layer 1038 is illustrated and can represent, for example, the machine 1100 of FIG. 11. The representative hardware layer 1038 includes a processing unit 1040 having associated executable instructions 1004. Executable instructions 1004 represent the executable instructions of the software architecture 1006, including implementation of the methods, components, and so forth described herein. The hardware layer 1038 also includes memory and/or storage modules 1042, which also have executable instructions 1004. The hardware layer 1038 may also comprise other hardware 1044.

In the example architecture of FIG. 10, the software architecture 1006 may be conceptualized as a stack of layers where each layer provides particular functionality. For example, the software architecture 1006 may include layers such as an operating system 1002, libraries 1020, frameworks/middleware 1018, applications 1016, and a presentation layer 1014. Operationally, the applications 1016 and/or other components within the layers may invoke application programming interface (API) calls 1008 through the software stack and receive a response such as messages 1012 in response to the API calls 1008. The layers illustrated are representative in nature and not all software architectures have all layers. For example, some mobile or special purpose operating systems may not provide a framework/middleware 1018, while others may provide such a layer. Other software architectures may include additional or different layers.

The operating system 1002 may manage hardware resources and provide common services. The operating system 1002 may include, for example, a kernel 1022, services 1024, and drivers 1026. The kernel 1022 may act as an abstraction layer between the hardware and the other software layers. For example, the kernel 1022 may be responsible for memory management, processor management (e.g., scheduling), component management, networking, security settings, and so on. The services 1024 may provide other common services for the other software layers. The drivers 1026 are responsible for controlling or interfacing with the underlying hardware. For instance, the drivers 1026 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 1020 provide a common infrastructure that is used by the applications 1016 and/or other components and/or layers. The libraries 1020 provide functionality that allows other software components to perform tasks in an easier fashion than to interface directly with the underlying operating system 1002 functionality (e.g., kernel 1022, services 1024, and/or drivers 1026). The libraries 1020 may include system libraries 1032 (e.g., C standard library) that may provide functions such as memory allocation functions, string manipulation functions, mathematical functions, and the like. In addition, the libraries 1020 may include API libraries 1034 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1020 may also include a wide variety of other libraries 1036 to provide many other APIs to the applications 1016 and other software components/modules.

The frameworks/middleware 1018 (also sometimes referred to as middleware) provide a higher-level common infrastructure that may be used by the applications 1016 and/or other software components/modules. For example, the frameworks/middleware 1018 may provide various graphical user interface (GUI) functions, high-level resource management, high-level location services, and so forth. The frameworks/middleware 1018 may provide a broad spectrum of other APIs that may be used by the applications 1016 and/or other software components/modules, some of which may be specific to a particular operating system 1002 or platform.

The applications 1016 include built-in applications 1028 and/or third-party applications 1030. Examples of representative built-in applications 1028 may include, but are not limited to, a contacts application, a browser application, a book reader application, a location application, a media application, a messaging application, and/or a game application. Third-party applications 1030 may include an application developed using the ANDROID™ or IOS™ software development kit (SDK) by an entity other than the vendor of the particular platform, and may be mobile software running on a mobile operating system such as IOS™ ANDROID™, WINDOWS® Phone, or other mobile operating systems. The third-party applications 1030 may invoke the API calls 1008 provided by the mobile operating system (such as operating system 1002) to facilitate functionality described herein.

The applications 1016 may use built in operating system functions (e.g., kernel 1022, services 1024, and/or drivers 1026), libraries 1020, and frameworks/middleware 1018 to create UIs to interact with users of the system. Alternatively, or additionally, in some systems, interactions with a user may occur through a presentation layer, such as presentation layer 1014. In these systems, the application/component “logic” can be separated from the aspects of the application/component that interact with a user.

FIG. 11 is a block diagram illustrating components of a machine 1100, according to some example embodiments, able to read instructions 1004 from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein may be executed. As such, the instructions 1110 may be used to implement modules or components described herein. The instructions 1110 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1100 capable of executing the instructions 1110, sequentially or otherwise, that specify actions to be taken by machine 1100. Further, while only a single machine 1100 is illustrated, the term “machine” shall also be taken to include a collection of machines that individually or jointly execute the instructions 1110 to perform any one or more of the methodologies discussed herein.

The machine 1100 may include processors 1104, memory/storage 1106, and I/O components 1118, which may be configured to communicate with each other such as via a bus 1102. The memory/storage 1106 may include a memory 1114, such as a main memory, or other memory storage, and a storage unit 1116, both accessible to the processors 1104 such as via the bus 1102. The storage unit 1116 and memory 1114 store the instructions 1110 embodying any one or more of the methodologies or functions described herein. The instructions 1110 may also reside, completely or partially, within the memory 1114, within the storage unit 1116, within at least one of the processors 1104 (e.g., within the processor's cache memory), or any suitable combination thereof, during execution thereof by the machine 1100. Accordingly, the memory 1114, the storage unit 1116, and the memory of processors 1104 are examples of machine-readable media.

The I/O components 1118 may include a wide variety of components to receive input, provide output, produce output, transmit information, exchange information, capture measurements, and so on. The specific I/O components 1118 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1118 may include many other components that are not shown in FIG. 11. The I/O components 1118 are grouped according to functionality merely for simplifying the following discussion and the grouping is in no way limiting. In various example embodiments, the I/O components 1118 may include output components 1126 and input components 1128. The output components 1126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1118 may include biometric components 1130, motion components 1134, environmental components 1136, or position components 1138 among a wide array of other components. For example, the biometric components 1130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1134 may include acceleration sensor components (e.g., accelerometer), gravitation sensor components, rotation sensor components (e.g., gyroscope), and so forth. The environmental components 1136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1118 may include communication components 1140 operable to couple the machine 1100 to a network 1132 or devices 1120 via coupling 1124 and coupling 1122, respectively. For example, the communication components 1140 may include a network interface component or other suitable device to interface with the network 1132. In further examples, communication components 1140 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1120 may be another machine or any of a wide variety of peripheral devices (e.g., a peripheral device coupled via a USB).

Moreover, the communication components 1140 may detect identifiers or include components operable to detect identifiers. For example, the communication components 1140 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 1110 for execution by the machine 1100, and includes digital or analog communications signals or other intangible medium to facilitate communication of such instructions 1110. Instructions 1110 may be transmitted or received over the network 1132 using a transmission medium via a network interface device and using any one of a number of well-known transfer protocols.

“CLIENT DEVICE” in this context refers to any machine 1100 that interfaces to a communications network 1132 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 1132.

“COMMUNICATIONS NETWORK” in this context refers to one or more portions of a network 1132 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 1132 or a portion of a network 1132 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 1110 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 1110. The term “machine-readable medium” shall also be taken to include any medium, or combination of multiple media, that is capable of storing instructions 1110 (e.g., code) for execution by a machine 1100, such that the instructions 1110, when executed by one or more processors 1104 of the machine 1100, cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 1104) may be configured by software (e.g., an application 1016 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 1104 or other programmable processor 1104. Once configured by such software, hardware components become specific machines 1100 (or specific components of a machine 1100) uniquely tailored to perform the configured functions and are no longer general-purpose processors 1104. It will be appreciated that the decision to implement a hardware component mechanically, in dedicated and permanently configured circuitry, or in temporarily configured circuitry (e.g., configured by software), may be driven by cost and time considerations.

Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 1104 configured by software to become a special-purpose processor, the general-purpose processor 1104 may be configured as respectively different special-purpose processors (e.g., comprising different hardware components) at different times. Software accordingly configures a particular processor or processors 1104, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 1102) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 1104 that are temporarily configured (e.g., by software) or permanently configured to perform the relevant operations. Whether temporarily or permanently configured, such processors 1104 may constitute processor-implemented components that operate to perform one or more operations or functions described herein. As used herein, “processor-implemented component” refers to a hardware component implemented using one or more processors 1104. Similarly, the methods described herein may be at least partially processor-implemented, with a particular processor or processors 1104 being an example of hardware. For example, at least some of the operations of a method may be performed by one or more processors 1104 or processor-implemented components. Moreover, the one or more processors 1104 may also operate to support performance of the relevant operations in a “cloud computing” environment or as a “software as a service” (SaaS). For example, at least some of the operations may be performed by a group of computers (as examples of machines 1100 including processors 1104), with these operations being accessible via a network 1132 (e.g., the Internet) and via one or more appropriate interfaces (e.g., an API). The performance of certain of the operations may be distributed among the processors 1104, not only residing within a single machine 1100, but deployed across a number of machines 1100. In some example embodiments, the processors 1104 or processor-implemented components may be located in a single geographic location (e.g., within a home environment, an office environment, or a server farm). In other example embodiments, the processors 1104 or processor-implemented components may be distributed across a number of geographic locations.

“PROCESSOR” in this context refers to any circuit or virtual circuit (a physical circuit emulated by logic executing on an actual processor 1104) that manipulates data values according to control signals (e.g., “commands,” “op codes,” “machine code,” etc.) and which produces corresponding output signals that are applied to operate a machine 1100. A processor 1104 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 1104 may further be a multi-core processor having two or more independent processors 1104 (sometimes referred to as “cores”) that may execute instructions 1110 contemporaneously.

What is claimed is:

1. A method comprising:
providing, by a cloud-based communication platform, an Application Programming Interface (API) for developing a voice extension, the API defining a set of functions and procedures that allows development of the voice extension;
receiving, by the cloud-based communication platform, the voice extension developed via the API;
receiving a command to invoke the voice extension; and
executing the voice extension to provide functionality that extends a base set of features provided by the cloud-based communication platform.

2. The method of claim 1, wherein the command comprises a voice extension identifier.

3. The method of claim 2, comprising:
accessing a set of code corresponding to the voice extension identifier from an extension repository; and
executing the set of code to generate a voice extension instance, the voice extension instance communicating with the cloud-based communication platform and an external computing system to provide the functionality that extends the base set of features.

4. The method of claim 3, comprising:
establishing a voice extension session by the voice extension instance; and
transferring communication functionalities of a previously established communication session to the voice extension session, the previously established communication session providing the base set of features.

5. The method of claim 4, comprising:
pausing the previously established communication session until a completion of the voice extension session.

6. The method of claim 4, comprising:
terminating the previously established communication session upon a completion of the voice extension session.

7. The method of claim 1, wherein the voice extension comprises one of a call processing and media session extension, a media stream extension, a media filter extension, a Dual-Tone Multi-Frequency (DTMF) extension, and a fire and forget extension.

8. The method of claim 1, wherein the functionality associated with the voice extension is provided without affecting operations of a previously established communication session.

9. The method of claim 1, comprising:
establishing a voice extension session during which operations of a previously established communication session are transferred from a first state to a second state that is controlled by a voice extension instance of the voice extension, the previously established communication session providing the base set of features.

10. The method of claim 9, comprising:
receiving a communication indicating a completion of the voice extension session; and
transferring the operations of the previously established communication session from the second state back to the first state.

11. A system comprising:
one or more processors; and
one or more computer-readable mediums storing instructions that, when executed by the one or more processors, cause the one or more processors to perform operations comprising:
providing, by a cloud-based communication platform, an Application Programming Interface (API) for developing a voice extension, the API defining a set of functions and procedures that allows development of the voice extension;
receiving, by the cloud-based communication platform, the voice extension developed via the API;
receiving a command to invoke the voice extension; and
executing the voice extension to provide functionality that extends a base set of features provided by the cloud-based communication platform.

12. The system of claim 11, wherein the command comprises a voice extension identifier.

13. The system of claim 12, wherein the operations comprise:
accessing a set of code corresponding to the voice extension identifier from an extension repository; and
executing the set of code to generate a voice extension instance, the voice extension instance communicating with the cloud-based communication platform and an external computing system to provide the functionality that extends the base set of features.

14. The system of claim 13, wherein the operations comprise:
establishing a voice extension session by the voice extension instance; and
transferring communication functionalities of a previously established communication session to the voice extension session, the previously established communication session providing the base set of features.

15. The system of claim 14, wherein the operations comprise:
pausing the previously established communication session until a completion of the voice extension session.

16. The system of claim 14, wherein the operations comprise:
terminating the previously established communication session upon a completion of the voice extension session.

17. The system of claim 11, wherein the voice extension comprises one of a call processing and media session extension, a media stream extension, a media filter extension, a Dual-Tone Multi-Frequency (DTMF) extension, and a fire and forget extension.

18. The system of claim 11, wherein the functionality associated with the voice extension is provided without affecting operations of a previously established communication session.

19. The system of claim 11, wherein the operations comprise:
establishing a voice extension session during which operations of a previously established communication session are transferred from a first state to a second state that is controlled by a voice extension instance of the voice extension, the previously established communication session providing the base set of features;
receiving a communication indicating a completion of the voice extension session; and
transferring the operations of the previously established communication session from the second state back to the first state.

20. A non-transitory computer-readable medium storing instructions that, when executed by one or more computer processors of a cloud-based communication platform, cause the cloud-based communication platform to perform operations comprising:
providing, by a cloud-based communication platform, an Application Programming Interface (API) for developing a voice extension, the API defining a set of functions and procedures that allows development of the voice extension;
receiving, by the cloud-based communication platform, the voice extension developed via the API;
receiving a command to invoke the voice extension; and
executing the voice extension to provide functionality that extends a base set of features provided by the cloud-based communication platform.
